(19) United States
(12) Patent Application Publication
(10) Pub. No.: US 2003/0062220 A1
(43) Pub. Date: Apr. 3, 2003

(54) Security and safety locking system for a tree stand

(76) Inventors: Scott A. Lewis, Hopewell, NJ (US); Frank B. Prato, Hamilton, NJ (US); Steven T. Ficarro, Hopewell, NJ (US)

Correspondence Address: DUANE MORRIS LLP, 100 COLLEGE ROAD WEST, SUITE 100, PRINCETON, NJ, 08540-6604, US

(21) Appl. No.: 10/226,855

(22) Filed: Aug. 23, 2002

Related U.S. Application Data
(60) Provisional application No. 60/314,675, filed on Aug. 24, 2001.

(51) Int. Cl. A01M 31/00

(52) U.S. Cl. 182/187

(57) ABSTRACT

A security and safety locking system for a portable tree stand, the system having a mounting plate to be permanently attached to the tree stand, for mounting the tree stand to a tree, a lock lug for fastening the mounting plate to the tree, and a locking block for lockably receiving a portion of the lock lug, to prevent unauthorized removal thereof.

### FIELD OF THE INVENTION

The present invention relates to a security and safety locking system for a portable tree stand.

### BACKGROUND OF THE INVENTION

Portable tree stands are well known in the art for use in supporting hunters, nature enthusiasts, photographers and others at an elevated position in a tree to allow viewing and observation of wildlife. A portable tree stand is typically constructed with a supporting platform that is attached to a trunk of a tree using a strap, belt, or chain.

Once a tree stand has been attached to a tree, they are usually left there for use later on. Because the straps, belts or chains which attach the tree stand to the trunk of the tree can be easily cut, tree stands are very susceptible to theft. Moreover, the straps, belts or chain do not provide a very good method for ensuring the stability of the tree stand. Accordingly, a system is need which addresses these problems.

### BRIEF DESCRIPTION OF THE DRAWINGS

The advantages, nature, and various additional features of the invention will appear more fully upon consideration of the illustrative embodiments now to be described in detail in connection with accompanying drawings where like reference numerals identify like elements throughout the drawings:

FIG. 1 is an exploded side view of a security and safety locking system according to an exemplary embodiment of the invention.

FIG. 2A is a side elevational view of a lock lug of the locking system of FIG. 1.

FIG. 2B is a head end view of the lock lug of FIG. 2B.

FIG. 3A is a plan view of a security mounting plate of the locking system of FIG. 1.

FIG. 3B is a plan view of the security mounting plate of FIG. 3A.

FIG. 4A is a side elevational view of a key actuated lock block of the locking system of FIG. 1.

FIG. 4B is a front elevational view of the lock block of FIG. 4A.

FIG. 4C is a rear elevational view of the lock block of FIG. 4A.

FIGS. 5A-5G are elevational views collectively showing the lock system in use with a conventional tree stand.

FIG. 6A is a partial sectional, side elevational view of a lock lug according to a second exemplary embodiment of the present invention.

FIG. 6B is a head end view of the lock lug of FIG. 6B.

FIG. 7A is a side elevational view of a key lock socket that may be used for driving the lock lug of FIGS. 6A and 6B.

FIG. 7B is a head end view of the key lock socket of FIG. 7A.

It should be understood that the drawings are for purposes of illustrating the concepts of the invention and are not necessarily to scale.

### DETAILED DESCRIPTION OF THE INVENTION

The security and safety locking system of the present invention prevents the unauthorized removal or accidental detachment (increases the stability of the tree stand) of a tree stand from its mounting in a tree. The locking system may be manufactured as an add-on system for virtually any tree stand, or may be integrally built into such tree stands. The locking system can also be used for locking other structures to various mountings.

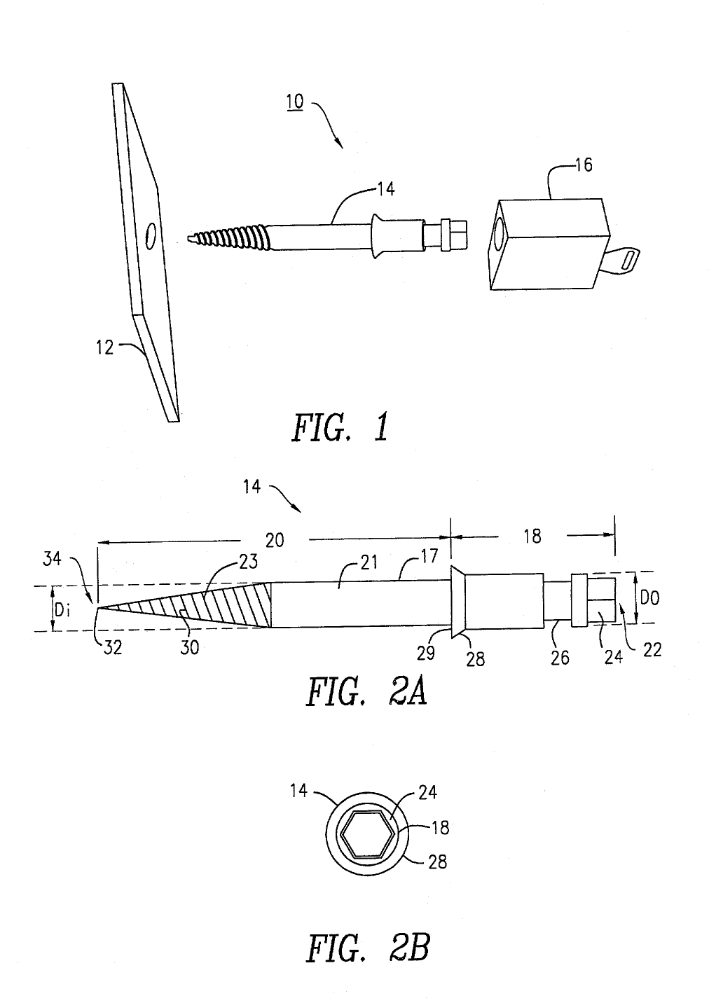

FIG. 1 shows an exploded view of the security and safety locking system 10 according to an exemplary embodiment of the invention. As can be seen, the locking system 10 in this embodiment may comprise a security mounting plate 12, a lock lug 14, and a key actuated lock block 16.

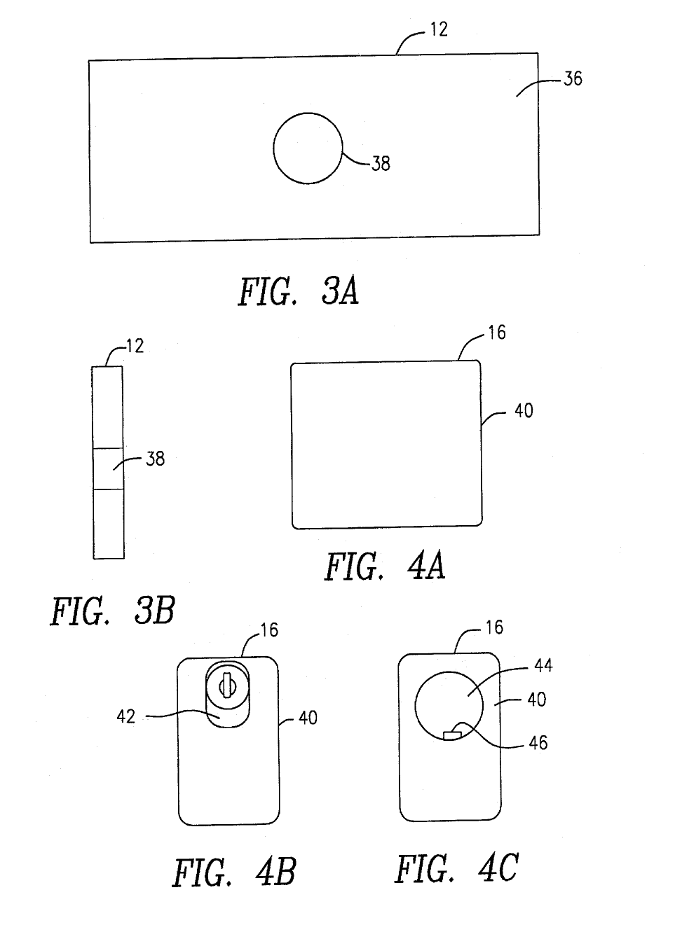

As shown collectively in FIGS. 2A and 2B, the lock lug 14 comprises a shaft 17 having a head end 22 and a leading end 34. The shaft 17 includes an outer shaft section 18 and an inner shaft section 20. The outer shaft section 18 is generally cylindrical and includes a lug drive member 24 formed at the head end 22, a lock pin groove 26 and an outwardly flared collar 28 that forms a stop surface 29. The drive member 24 can be configured, for example, as a hex drive nut. The inner shaft section 20 includes cylindrical portion 21 and tapered portion 23. The cylindrical portion 21 has an outer diameter Dᵢ which is typically slightly less than the outer diameter Dₒ of the outer shaft section 18. The tapered portion 23 tapers down to a generally pointed tip 32. A thread 30, extending from the tip 32 to the cylindrical portion 21, is formed on the outer surface of the tapered portion 23. The thread 30 may be any self-tapping, helical or like design so as to facilitate relatively easy threading of the lock lug 14 into a tree trunk or other relatively soft structure without breaking of the lock lug 14.

The lock lug 14 is preferably made from tempered steel because it resists attempts to cut the shaft sections using various types of cutting tools. However, it should be understood that the lock lug 14 may be made from any other suitable material.

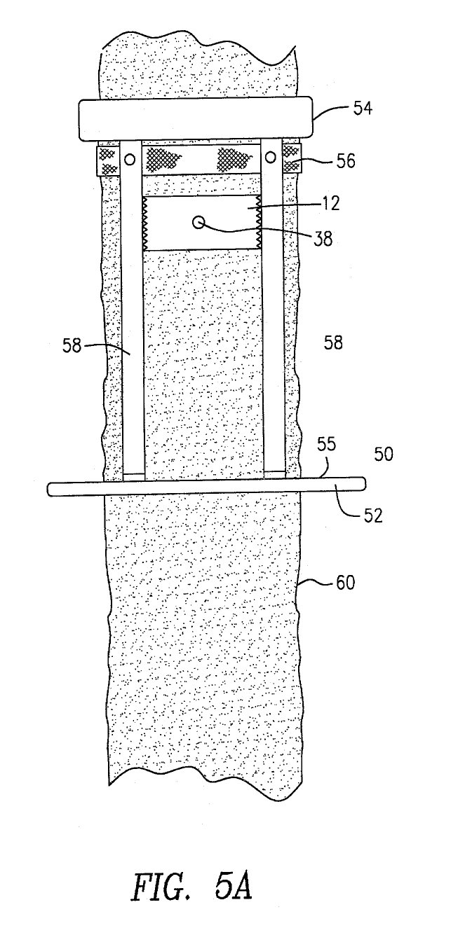

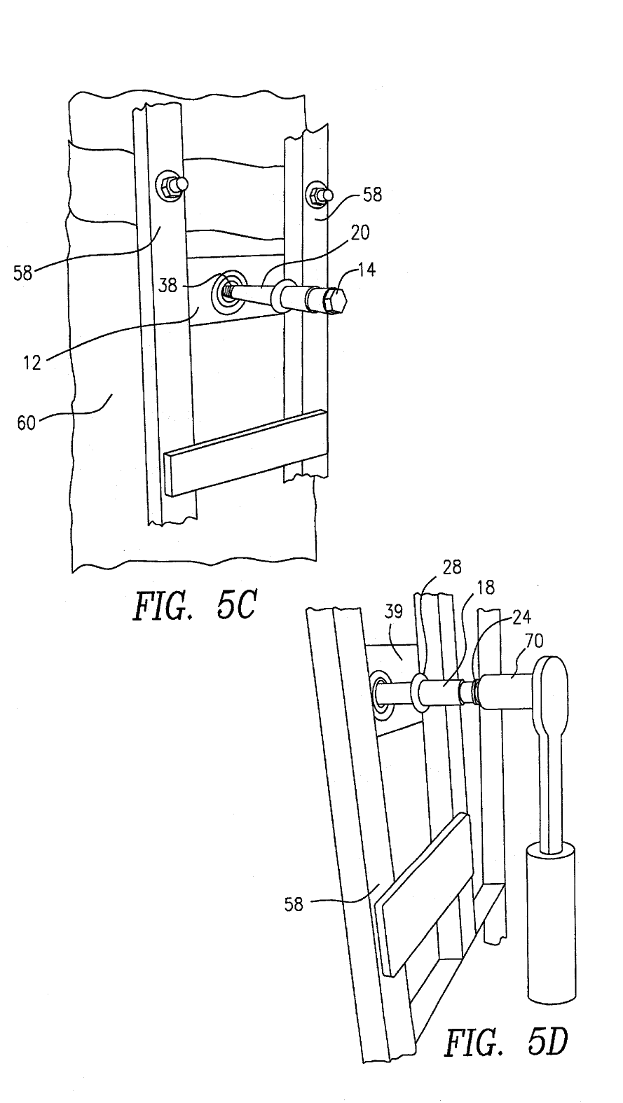

As collectively shown in FIGS. 3A and 3B, the security mounting plate 12 is typically includes a rigid, substantially planar plate member 36 for attachment to a tree stand. The plate member 36 may also be curved or bent in a manner which approximately matches the contour of the tree. The plate member 36 includes an aperture 38 which is sized to allow only the inner shaft section 20 of the lock lug 14 to pass therethrough. The mounting plate 12 may be made from any suitably rigid material, such as aluminum or steel (typically matched to the material of the tree stand), and may be permanently attached to a tree stand 50 as shown in FIG. 5A by welding, brazing or any other suitable fixing method. In applications where the locking system is built into the tree stand, the mounting plate 12 may form an integral element of the tree stand structure.

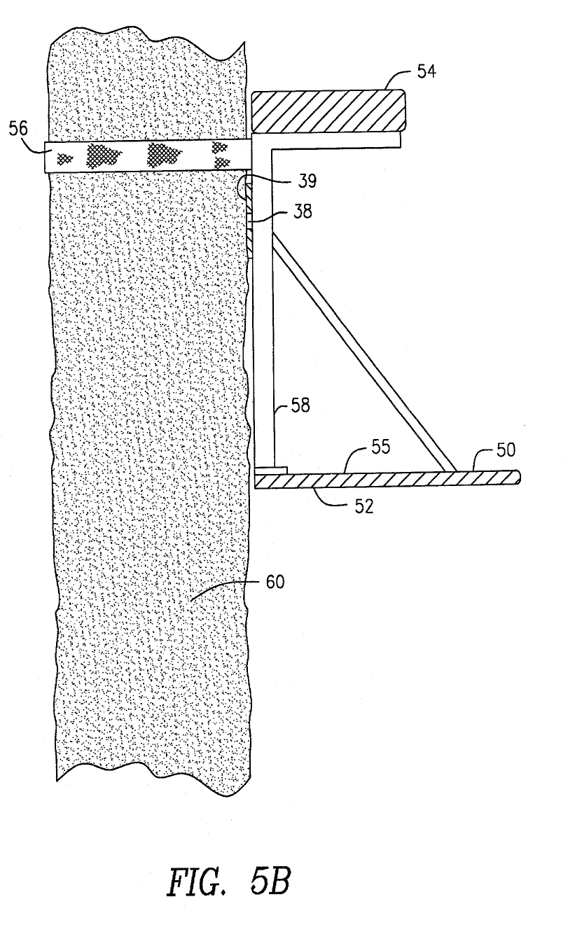

As shown together in FIGS. 4A-4C, the key actuated lock block 16 typically includes a block member 40 that houses a key actuated lock cylinder 42. The block member 40 includes a closed-ended bore or receptacle 44 that is typically sized to receive almost the entire length of the outer shaft section 18 of the lock lug 14, except the stop collar 28. A tumbler lock pin 46 associated with the lock cylinder 42 can be selectively extended into the bore 44 via actuation of the lock cylinder 42 with a conventional key (not shown) to lockingly engage the lock pin groove 26 defined in the outer shaft section 18 of the lock lug 14, thereby locking the lock block 16 to the lock lug 14. When the lock block 16 is locked onto the lock lug 14, access to the lock lug 14 is substantially prevented. The lock pin 46 disengages from the groove 26 when the lock cylinder 42 is unlocked with the key.

FIGS. 5A-5G collectively show the lock system in use with a conventional tree stand 50. As shown in FIG. 5A, the tree stand 50 includes a platform 52 having a seat 54 mounted to an upper surface 55 thereof. A strap, chain, cable or other attaching means 56 attaches the tree stand 50 to the trunk of a tree 60. The security mounting plate 12 is welded, brazed or otherwise attached to the support legs 58 of the seat 54 or any other suitable area of the tree stand 50, such as the platform 52, prior to mounting the tree stand 50 in the tree 60. The mounting plate 12 should be attached to the tree stand 50 so that the rear face 39 of the plate 12 engages the outer surface of the tree trunk 60 as shown in FIG. 5B.

As shown in FIG. 5C, the inner shaft section 20 of the lock lug 14 is then inserted through the aperture 38 in the security mounting plate and the tip (not visible) at the leading end of the lock lug 14 is pressed into the surface of the tree trunk 60.

In FIG. 5D, a driver 70 such as a ratchet and socket arrangement, is attached to the drive member 24 of the outer shaft section 18 of the lock lug 14. The driver 70 is used to thread the lock lug 14 into the trunk of the tree 60. The inner shaft section 20 of the lock lug 14 penetrates into the trunk of the tree 60 as the lock lug 14 is threaded until the stop surface 29 of the outer shaft section collar 28 abuts against the front face 39 of the mounting plate 12 as shown in FIG. 5E.

As shown in FIG. 5F, the lock block 16 is then installed over the outer shaft section 18 (not visible) of the lock lug 14. With the lock block 16 locked onto the lock lug 14, access to the drive member 24 and other portions of the lock lug 14 is substantially prevented. A lock block cover 80 made from plastic or any other suitable material may be installed over the lock block 16 to prevent moisture and dirt from entering the lock cylinder 42 of the lock block 16, thus, providing weatherproofing as shown in FIG. 5G.

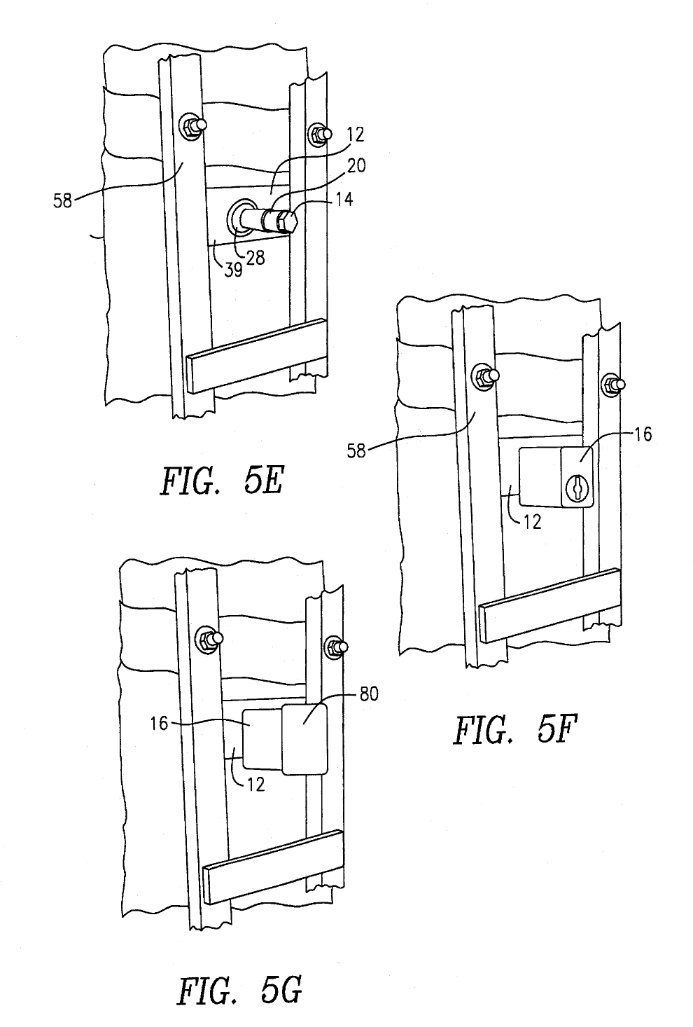

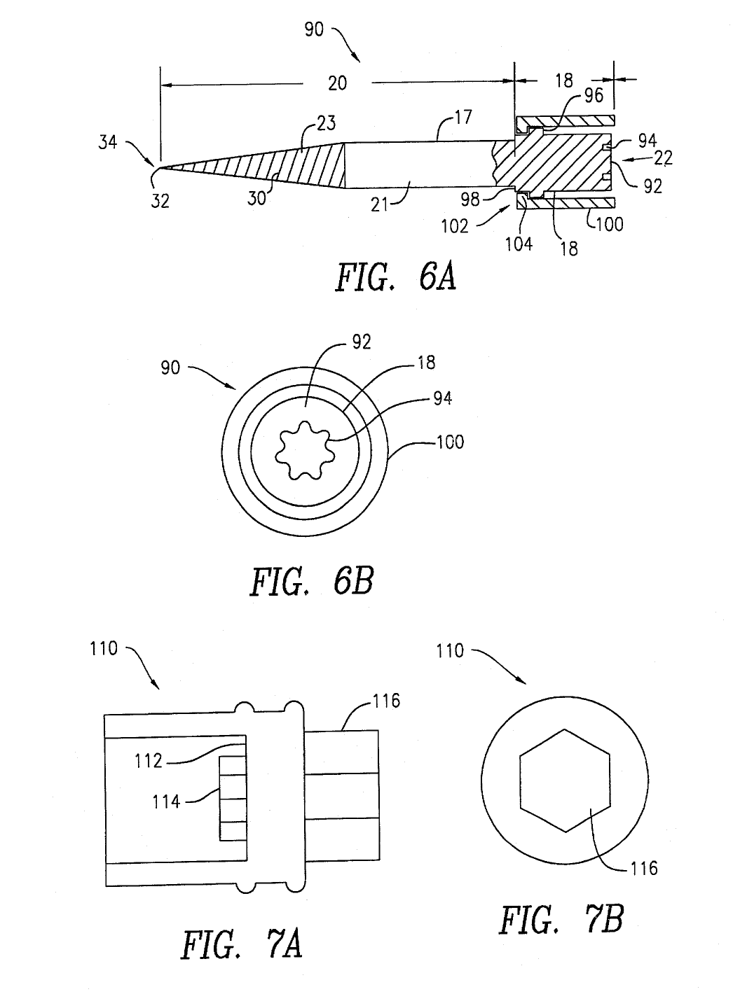

FIGS. 6A and 6B collectively show a lock lug 90 according to a second exemplary embodiment of the present invention. The lock lug 90 is substantially identical to the lock lug 14 of FIGS. 2A and 2B except, that the outer shaft section 18 of lock lug 90 has a lug drive member comprised of a curvilinear groove 94 formed in an end surface 92 of the outer shaft section 18, which is driven by a key lock socket 110 (FIGS. 7A and 7B). A similar lug driving arrangement for an automotive wheel application is described in U.S. Pat. No. 3,241,408 issued to McCauley.

Referring still to FIGS. 6A and 6B, the outer shaft section 18 of lock lug 90 also includes an outwardly directed, collar retaining flange 96. The collar retaining flange 96 is disposed marginally adjacent to an annular stop surface 98 (for abutting against the front face 39 of the mounting plate 12 for the same purpose as described above with respect to the lock lug 14 of FIGS. 2A and 2B) defined by the outer shaft section 18, where it interfaces with the small diameter inner shaft section 20. A collar member 100 is rotatively disposed about the outer shaft section 18. The leading end 102 of the collar 100 includes an inwardly directed lip 104 that engages the collar retaining flange 96 of the outer shaft section 18. As with the lock lug 90, the collar 100 may be made from tempered steel or any other suitable material.

As shown in FIGS. 7A and 7B, the key lock socket 110 includes a raised flange 114 formed at a bottom surface 112 of the socket 110. The flange 114 is formed in the same curvilinear configuration as the groove 94 of the lock lug 90 to allow engagement therewith to transfer rotational torque to the lock lug 90. Each lock lug 90 and corresponding key lock 110 have their own groove/flange curvilinear configuration. The key lock socket 110 further includes its own drive member 116, for example, a hex drive nut, that enables the key lock socket 110 to be driven with a conventional ratchet and socket arrangement (not shown).

In use, the lock lug 90 of FIGS. 6A and 6B is threaded, via the key lock socket 110, into the tree until annular abutment surface 98 of the outer shaft section 18 abuts against the security mounting plate 12. This traps the lip 104 of the collar 100 between the security mounting plate 12 and the collar retaining flange 96 of the outer shaft section 18, thus preventing removal of the collar from the lock lug 90. The collar 100, however, is still capable of freely rotating on the outer shaft section 18 of the lug 90, thereby blocking access to the outer shaft section 18 of the lug, which is the only exposed portion of the lug 90. Hence, the collar 100 operates to resist removal of the lock lug 90 by removing the outer shaft section 18 using unauthorized tools, such as lock cutters, saws and the like.

The security and safety locking system of the present invention is relatively compact and light-weight. Accordingly, it may be placed into small garments for carrying. Moreover, the locking system may be manufactured in various sizes to accommodate different applications. Additionally, the locking system may be painted a non-conspicuous color to blend with the tree stand and the environment.

While the foregoing invention has been described with reference to the above embodiments, various modifications and changes can be made without departing from the spirit of the invention.

What is claimed is:

1. A security and safety locking system for a portable tree stand, the system comprising:
a mounting plate to be permanently attached to the tree stand, the mounting plate for mounting the tree stand to a tree, the mounting plate having an aperture extending therethrough;
a lock lug for fastening the mounting plate to the tree, the lock lug comprising a shaft for insertion through the aperture, the shaft including an outer shaft section having lug drive member formed at an end thereof for attaching a driver which rotatively drives the lock lug, and an inner shaft section having a thread formed thereon for enabling the inner section of the shaft to at least partially penetrate into the tree when the lock lug is rotatively driven by the driver; and
a locking block comprising a block member having a receptacle sized for lockably receiving at least the lug drive member of the outer shaft section, to block access to the lug drive member.

2. The security and safety locking system according to claim 1, wherein the outer shaft section further has a stop surface for engaging the mounting plate when the lock lug is rotatively driven to penetrate the tree, for limiting the distance the shaft extends through the aperture of the mounting plate.

3. The security and safety locking system according to claim 2, wherein the receptacle of the block member is sized for receiving substantially the entire outer shaft section except the stop surface.

4. The security and safety locking system according to claim 1, wherein the locking block further comprises a locking pin which lockingly engages a groove formed in the outer shaft section to lock the locking block to the lock lug.

5. The security and safety locking system according to claim 4, wherein the locking block further comprises lock cylinder means for actuating the locking pin.

6. The security and safety locking system according to claim 1, further comprising a lock block cover for encasing the locking block.

7. A portable tree stand comprising:
a platform assembly;
means for attaching the platform to a tree;
a mounting plate attached to the platform assembly for mounting the tree stand to a tree, the mounting plate having an aperture extending therethrough;
a lock lug for fastening the mounting plate to the tree, the lock lug comprising a shaft for insertion through the aperture, the shaft including an outer shaft section having lug drive member formed at an end thereof for attaching a driver which rotatively drives the lock lug, and an inner shaft section having a thread formed thereon for enabling the inner section of the shaft to at least partially penetrate into the tree when the lock lug is rotatively driven by the driver; and
a locking block comprising a block member having a receptacle sized for lockably receiving at least the lug drive member of the outer shaft section, to block access to the lug drive member.

8. The tree stand according to claim 7, wherein the outer shaft section further has a stop surface for engaging the mounting plate when the lock lug is rotatively driven to penetrate the tree, for limiting the distance the shaft extends through the aperture of the mounting plate.

9. The tree stand according to claim 8, wherein the receptacle of the block member is sized for receiving substantially the entire outer shaft section except the stop surface.

10. The tree stand according to claim 7, wherein the locking block further comprises a locking pin which lockingly engages a groove formed in the outer shaft section to lock the locking block to the lock lug.

11. The tree stand according to claim 10, wherein the locking block further comprises lock cylinder means actuating for the locking pin.

12. The tree stand according to claim 7, further comprising a lock block cover for encasing the locking block.

13. A security and safety locking system for a portable tree stand, the system comprising:
a mounting plate to be permanently attached to the tree stand, the mounting plate for mounting the tree stand to a tree, the mounting plate having an aperture extending therethrough;
a lock lug for fastening the mounting plate to the tree, the lock lug comprising a shaft for insertion through the aperture, the shaft including an outer shaft section having a lug drive member formed at an end thereof, and an inner shaft section having a thread formed thereon for enabling the inner section of the shaft to at least partially penetrate into the tree when the lock lug is rotatively driven; and
a driver for engaging the lug drive member to rotatively drive the lock lug;
wherein the lug drive member is formed by a groove having a selected curvilinear configuration, and the driver includes a flange having a selected curvilinear configuration matching the selected curvilinear configuration of the groove, the matching curvilinear configurations of the groove and flange preventing unauthorized removal of the lock lug from the mounting plate using another driver.

14. The security and safety locking system according to claim 13, wherein the outer shaft section further has a stop surface that engages the mounting plate when the lock lug is rotatively driven to penetrate the tree, for limiting the distance the shaft extends through the aperture of the mounting plate.

15. The security and safety locking system according to claim 13, further comprising a collar disposed about the outer shaft section.

16. The security and safety locking system according to claim 15, wherein the collar free rotates about the outer shaft section when the lock lug is fully driven into the tree.

17. The security and safety locking system according to claim 13, further comprising means for blocking access to the outer shaft section.

18. A portable tree stand comprising:
a platform assembly;
means for attaching the platform to a tree;
a mounting plate attached to the platform assembly for mounting the tree stand to a tree, the mounting plate having an aperture extending therethrough;
a lock lug for fastening the mounting plate to the tree, the lock lug comprising a shaft for insertion through the aperture, the shaft including an outer shaft section having a lug drive member formed at an end thereof, and an inner shaft section having a thread formed thereon for enabling the inner section of the shaft to at least partially penetrate into the tree when the lock lug is rotatively driven; and
a driver for engaging the lug drive member to rotatively drive the lock lug;
wherein the lug drive member is formed by a groove having a selected curvilinear configuration and the driver includes a flange having a selected curvilinear configuration matching the selected curvilinear configuration of the groove, the matching curvilinear configurations of the groove and flange preventing unauthorized removal of the lock lug from the mounting plate using another driver.

19. The tree stand according to claim 18, wherein the outer shaft section further has a stop surface that engages the mounting plate when the lock lug is rotatively driven to penetrate the tree, for limiting the distance the shaft extends through the aperture of the mounting plate.

20. The tree stand according to claim 18, further comprising a collar disposed about the outer shaft section.

21. The tree stand according to claim 20, wherein the collar freely rotates about the outer shaft section when the lock lug is fully driven into the tree.

22. The tree stand according to claim 18, further comprising means for blocking access to the outer shaft section.

23. A security and safety locking system comprising:
a mounting plate to be permanently attached to a first structure, the mounting plate for mounting the first structure to a second structure, the mounting plate having an aperture extending therethrough;
a lock lug for fastening the mounting plate to the second structure, the lock lug comprising a shaft for insertion through the aperture, the shaft including an outer shaft section having lug drive member formed at an end thereof for attaching a driver which rotatively drives the lock lug, and an inner shaft section having a thread formed thereon for enabling the inner section of the shaft to at least partially penetrate into the second structure when the lock lug is rotatively driven by the driver; and
a locking block comprising a block member having a receptacle sized for lockably receiving at least the lug drive member of the outer shaft section, to block access to the lug drive member.

24. A security and safety locking system comprising:
a mounting plate to be permanently attached to a first structure, the mounting plate for mounting the first structure to a second structure, the mounting plate having an aperture extending therethrough;
a lock lug for fastening the mounting plate to the second structure, the lock lug comprising a shaft for insertion through the aperture, the shaft including an outer shaft section having a lug drive member formed at an end thereof, and an inner shaft section having a thread formed thereon for enabling the inner section of the shaft to at least partially penetrate into the second structure when the lock lug is rotatively driven; and
a driver for engaging the lug drive member to rotatively drive the lock lug;
wherein the lug drive member is formed by a groove having a selected curvilinear configuration, and the driver includes a flange having a selected curvilinear configuration matching the selected curvilinear configuration of the groove, the matching curvilinear configurations of the groove and flange preventing unauthorized removal of the lock lug from the mounting plate using another driver.
